(19) United States
(12) Patent Application Publication
(10) Pub. No.: US 2018/0283549 A1
(43) Pub. Date: Oct. 4, 2018

(54) TRANSMISSION AND METHOD FOR OPERATING AN AUTOMATIC TRANSMISSION

(71) Applicant: ZF Friedrichshafen AG, Friedrichshafen (DE)

(72) Inventor: Johannes KALTENBACH, Friedrichshafen (DE)

(21) Appl. No.: 15/767,504

(22) PCT Filed: Sep. 27, 2016
(86) PCT No.: PCT/EP2016/072895

§ 371 Date: Apr. 11, 2018

(30) Foreign Application Priority Data
Oct. 12, 2015 (DE) 10 2015 219 723.9

(51) Int. Cl. F16H 61/70; F16H 61/02

(52) U.S. Cl. CPC F16H 61/702; F16H 2061/0216; F16H 61/0213

(57) ABSTRACT

A transmission and a method for operating an automated transmission having a main transmission group and at least one splitter group for producing at least six gears. The gear interval at least in a gearshift between the gears with the lowest and second-lowest gear ratios is chosen to be smaller than the gear interval at least between the gears with the highest and the second-highest gear ratios. At least in the gearshift between the gears with the lowest and second-lowest gear ratios, a shifting element in use associated with the splitter group and a shifting element in use associated with the main transmission group are changed. At least in a gearshift between the gears with the highest and the second-highest gear ratios, a shifting element in use associated with the main transmission group is not changed and a shifting element in use associated with the splitter group is changed.

This application is a national stage completion of PCI/EP2016/072895 filed Sep. 27, 2016 which claims priority from German Application Serial No. 10 2015 219 723.9.

### FIELD OF THE INVENTION

The present invention relates to a transmission and a method for operating an automatic transmission or an automated transmission having a main transmission group and a splitter group.

### BACKGROUND OF THE INVENTION

For example, from the document EP 2 249 0 62 A1 a method for operating a drive-train is known. The drive-train comprises a group transmission with a multi-step main transmission group, An intermediate group in the form of a splitter group is connected upstream from the main transmission group and a range group is connected downstream from the main transmission group. By virtue of the for example 2-stage splitter group connected upstream, the gear intervals of the main transmission group are halved and the total number of gears available in the group transmission is doubled, By virtue of the for example 2-stage range group connected downstream, the total number of gears available in the group transmission is doubled again. With the upstream splitter group and the main transmission group the group transmission comprises a plurality of spur gear planes and a plurality of shifting elements associated with the spur gear planes for producing several gear ratios. Each spur gear plane comprises a spur gearwheel in the form of a loose wheel associated with the transmission input shaft or main shaft, which meshes respectively with a spur gearwheel associated with the countershaft. By means of the shifting elements provided, the loose wheels can be connected to the transmission input shaft or the main shaft.

Automated range-change transmissions in the form of 12-gear or 16-gear versions with a splitter group, a main group and a range group are preferably designed for use in trucks. The group transmission described above has geometrically designed gear intervals, i.e. in essence the gear intervals or gear ratio intervals between two adjacent gears are always the same. The splitter group divides the gear ratios of the main transmission group into two gear ratios in each case. The downstream range group enables the existing gear ratios to be doubled.

A truck, for example used on long-haul journeys, moves along freeways at almost constant speed. On flat ground a low engine rotational speed is desirable for consumption reasons. However, on inclines downshifts are needed in order to increase the engine rotational speed and hence the drive power. For such gearshifts in the gears with lower ratios, for example in a 12-gear transmission between the ratios 10 to 12, it would be advantageous to have a smaller gear interval in order to be able always to drive as close as possible to the consumption optimum of the internal combustion engine. However, with the transmission described above with its geometric transmission spread, if the gear intervals are reduced so also the overall spread of the transmission is also reduced substantially, which is a disadvantage.

### SUMMARY OF THE INVENTION

The purpose of the present invention is to propose a transmission and a method for operating a transmission, which enables the gear intervals to be reduced as much as possible without reducing the spread of the transmission.

According to the invention, this objective is achieved by virtue of the characteristics specified in the independent claims, whereas advantageous further developments emerge from the subordinate claims, the description and the drawings.

Thus, in the context of the invention a transmission and a method for operating an automated transmission are proposed. The transmission comprises a main transmission group and a splitter group, which taken together comprise at least four spur gear planes and at least five shifting elements associated with the spur gear planes in order to obtain at least six gear ratios, According to the invention, in order to obtain a progressive gear ratio series with an approximately constant transmission spread, the gear interval at least in a gearshift between the gear steps with the lowest gear ratio and the second-lowest gear ratio is chosen to be smaller than the gear interval at least between the gears with the highest gear ratio and the second-highest gear ratio. In particular this is achieved in that at least in the gearshift between the gear steps with the lowest and the second-lowest gear ratios, those shifting elements used which are associated with the splitter group are not changed whereas those shifting elements used which are associated with the main group are changed, and at least in a gearshift between the gear steps with the highest and the second-highest gear ratios the shifting element used which is associated with the main transmission group is not changed whereas the shifting element used which is associated with the splitter group is changed.

As a result a larger gear interval is associated with the lower gears and a smaller gear interval is associated with the higher gears. In this way, on the one hand, an approximately constant transmission spread and, on the other hand, a progressive gear ratio series are obtained.

In the context of the invention, at least two gear steps of the main transmission group, each represented by a wheel plane, are designed with a small gear interval relative to one another, the gear steps or gears of the main transmission group concerned being the two highest gears, i.e. those with the lowest gear ratio. The smaller gear interval is obtained by virtue of the stationary gear ratio between the second spur gear plane or spur gear ratio stage and the third spur gear plane, whereas the larger gear interval is produced by the stationary gear ratio between the first spur gear plane and the second spur gear plane. Preferably, the larger gear interval corresponds approximately to the square of the smaller gear interval. However, other values are also conceivable.

In a further development of the invention, it can be provided that by the use of a further spur gear plane of the main transmission group and a further, sixth shifting element associated with the main transmission group two more gear ratio steps can be produced. Thus, the invention is used not only with six-gear transmissions, but also with an eight-gear transmission.

If the invention provides that a range group in the form of a planetary gearset with a first range-change shifting element and a second range-change shifting element is connected downstream from the main transmission group, at least four to six further gear ratios can be obtained. Consequently, by doubling the gear steps the invention can also be implemented in a 10-gear or 12-gear transmission or in a 14-gear transmission, in order to obtain a progressive gear ratio series while the transmission spread remains approximately the same.

### BRIEF DESCRIPTION OF THE DRAWINGS

Below, the present invention is explained further with reference to the drawings, which show:

FIG. 1: A representation of the principle of a gearset layout for an automated transmission;

FIG. 1A: Stationary gear ratios of the wheel planes of the gearset layout according to FIG. 1;

FIG. 1B: A shifting matrix for the gearset layout according to FIG. 1;

FIG. 1C: Representation of the principle of alternative stationary gear ratios of the wheel planes of the gearset layout according to FIG. 1;

FIG. 1D a An alternative shifting matrix for the gearset layout according to FIG. 1;

FIG. 2: A representation of the principle of a further gearset layout of the automated transmission;

FIG. 2A: Stationary gear ratios of the wheel planes of the gearset layout according to FIG. 2;

FIG. 2B: A shifting matrix for the gearset layout according to FIG. 2;

FIG. 3: A representation of the principle of a further gearset layout of the automated transmission;

FIG. 3A: Stationary gear ratios of the wheel planes of the gearset layout according to FIG. 3;

FIG. 3B: A shifting matrix for the gearset layout according to FIG. 3;

FIG. 4: A representation of the principle of a further gearset layout of the automated transmission;

FIG. 4A: Stationary gear ratios of the wheel planes of the gearset layout according to FIG. 4;

FIG. 4B: A shifting matrix for the gearset layout according to FIG. 4;

FIG. 5: A representation of the principle of a further gearset layout of the automated transmission;

FIG. 5A: Stationary gear ratios of the wheel planes of the gearset layout according to FIG. 5; and

FIG. 5B: A shifting matrix for the gearset layout according to FIG. 5.

### DETAILED DESCRIPTION OF THE PREFERRED EMBODIMENTS

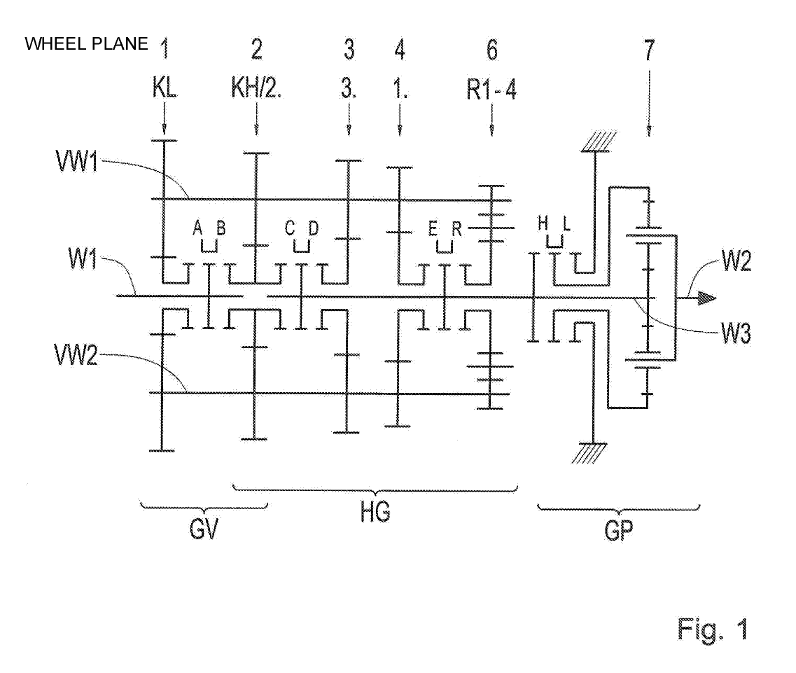

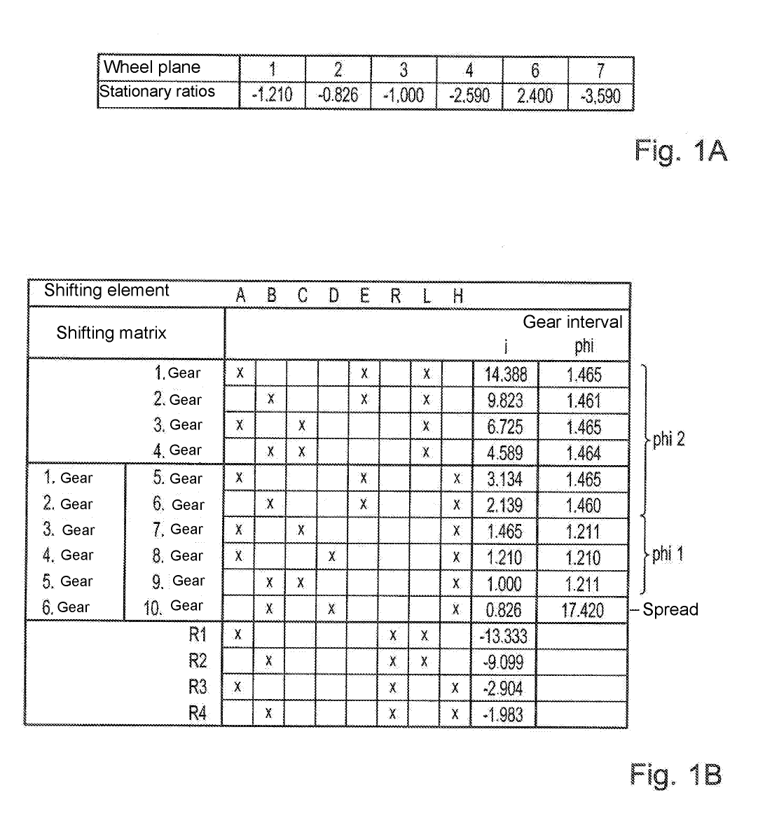

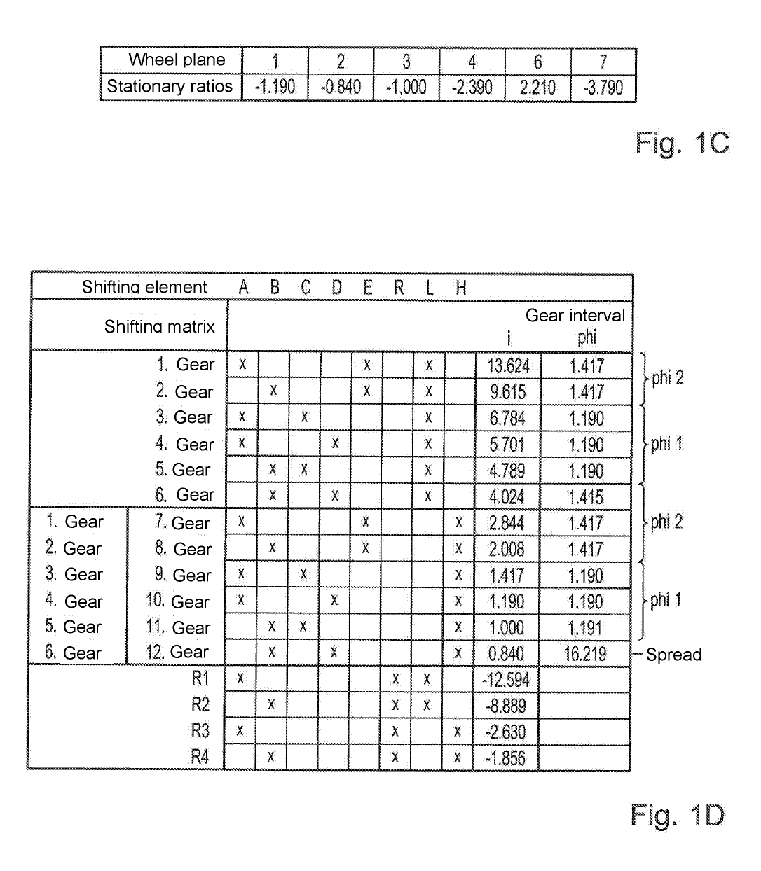

FIGS. 1 to 5 show as examples various gearset layouts of an automated transmission, with reference to which examples of the invention will be described. The gearset layouts comprise a main transmission group HG and connected upstream therefrom a splitter group VG, whereas the range group GP also shown connected downstream is not imperatively necessary for the invention.

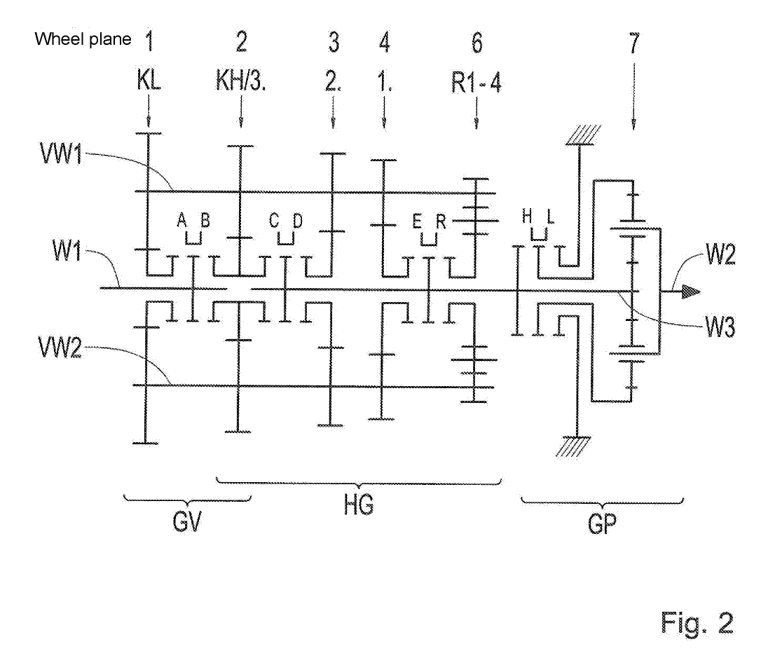

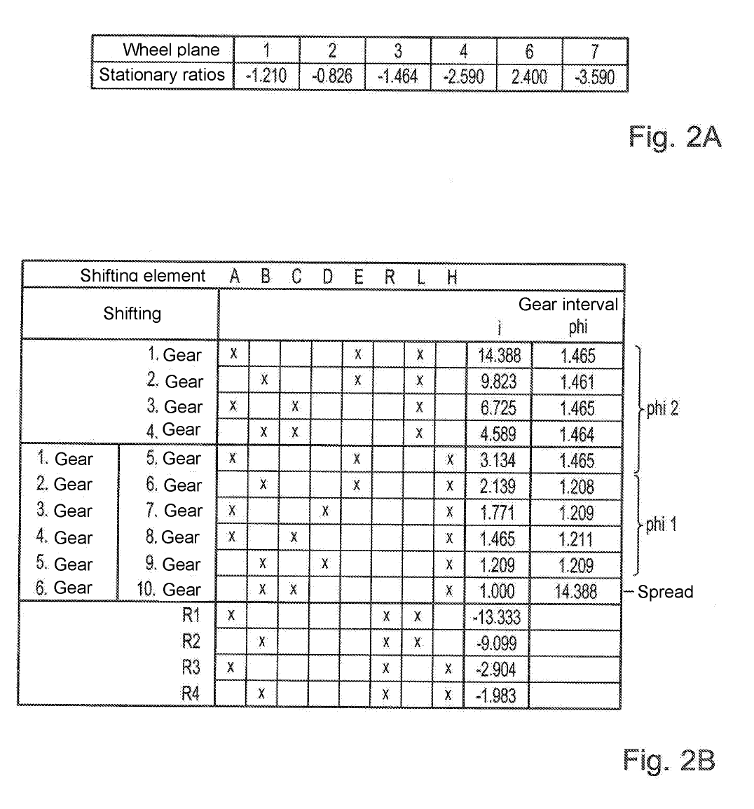

In FIGS. 1 and 2 the main transmission group HG and the splitter group VG comprise four wheel planes 1, 2, 3, 4, with which are associated five shifting elements A, B, C, D, E in order to be able to connect the loose wheels to the drive input shaft W1 or to the main shaft W3. The loose wheels engage with at least one fixed wheel of a countershaft VW1, In the gearset layouts shown here, a second countershaft VW2 is additionally provided, although this is optional. Associated with the main transmission group HG there is in addition a sixth spur gear plane R1-4 for the reversing gear ratios, and this is associated with an additional shifting element R.

The first spur gear plane 1 is associated with the splitter group GV with a drive input constant KL, while the second spur gear plane 2 is associated both with the splitter group GV and with the main transmission group HG. In this way the second spur gear plane 2 is used twice as much, so that it is associated with the drive input constant KH and at the same time the second gear ratio step 2. of the main transmission group HG. The third spur gear plane 3 and the fourth spur gear plane 4 are associated with the main transmission group HG, so that the third spur gear plane 3 is associated with the third gear ratio step 3. of the main transmission group HG and the fourth spur gear plane 4 with the first gear ratio step 1, of the main transmission group HG.

As already mentioned, the optionally usable range group GP can be connected by way of the main shaft W3 and the first range-change shifting element L and the second range-change shifting element H to the drive output shaft W2. A planetary gearset is provided as the range group GP.

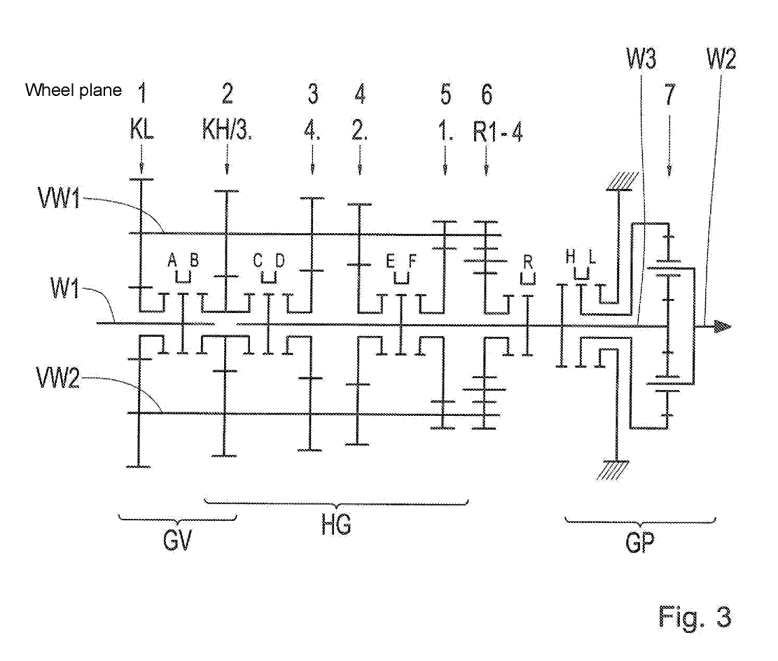

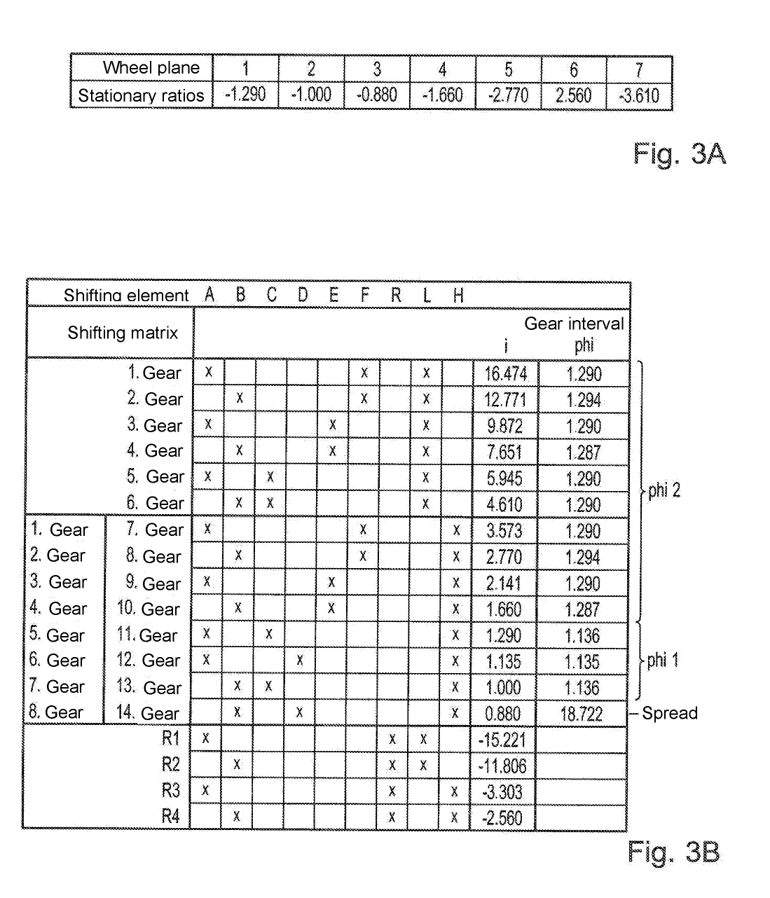

The gearset layouts shown in FIGS. 3 to 5 differ essentially in that a further, fifth spur gear plane 5 is associated with the main transmission group HG, with the sixth shifting element F associated with it. Consequently, with the gearset layouts according to FIGS. 1 and 2 a minimum of 6 forward gears or gear ratios and a maximum of 12 forward gears or gear ratios can be obtained, whereas with the gearset layouts according to FIGS. 3 to 5 a minimum of 3 forward gears and a maximum of 14 forward gears can be obtained.

In the shifting schemes associated with the gearset layouts according to FIGS. 1B, 1D, 2B, 3B, 4B and 5B, in each case the gear ratios of the gear ratio steps of the transmission shown are given as examples. In addition, the gear intervals phi provided between the gear ratio steps shown and the overall spread of the transmission are indicated. Furthermore, the shifting elements closed in order to obtain the respective gears are indicated by corresponding crosses in the table. Since in the context of the invention the proposed method can also be used with transmissions not having a range group GP, besides the possible gear steps the gears that can be obtained without using the range group GP are also indicated in parallel, so that all the gearset layouts are claimed by the invention in relation to the indicated gear ratios and gear intervals and the respective spreads.

In addition, for each gearset layout shown in FIGS. 1 to 5, the respective possible stationary gear ratios of the individual spur gear planes 1 to 7 are indicated as examples in FIGS. 1A, 1C, 2A, 3A, 4A and 5A, whereas the sixth wheel plane 6 is the spur gear plane for the reversing gear ratios and the seventh wheel plane forms the optional range group GP. The stationary gear ratios given for each case correspond to the respective tooth number ratios between the spur gears of the spur gear planes concerned. In the case of the seventh wheel plane 7, which relates to the planetary gearset, the stationary gear ratio corresponds to the tooth number ratio between the ring gear and the sun gear. The gear ratios of the spur gear pairs in the first two spur gear planes 1, 2 are provided from the drive input shaft W1 to the countershaft VW1 and in the spur gear planes 3, 4 and 6 from the first countershaft VWI to the main shaft W3, wherein the numerical values of the stationary gear ratios are only given as examples.

In order to obtain in the transmission a progressive gear ratio series with an approximately constant transmission spread, at least in the case of a gearshift between the gears with the lowest ratio i and the second-lowest ratio i a smaller gear interval phi 1 is provided than the gear interval phi 2 at least in the case of a gearshift between the gears with the highest ratio i and the second-highest ratio i. Furthermore, it is provided that at least in the case of the gearshift between the gears with the lowest ratio i and the second-lowest ratio i the shifting element A, B used and associated with the splitter group GV remains closed and the shifting element C, D, E used and associated with the main transmission group HG can be changed, whereas at least in the case of a gearshift between the gears with the highest ratio i and the second-highest ratio i the shifting element C, D. E associated with the main transmission group HG remains closed and the shifting element A, B used and associated with the splitter group GV can be changed.

Regardless of the various gearset layouts it is provided, that to obtain the gear ratio step with the highest gear ratio i the first of the shifting elements A associated with the splitter group GV and the fifth or sixth shifting element E or F associated with the main transmission group HG is closed, and to obtain the gear ratio step with the second-highest gear ratio i the second of the shifting elements B associated with the splitter group GV and the fifth or sixth shifting element E or F associated with the main transmission group HG are closed. Further, it is provided that to obtain the gear ratio step with the second-lowest gear ratio i the first or second shifting element A or B associated with the splitter group GV and the third or fourth shifting element C or D associated with the main transmission group HG are dosed, and to obtain the gear ratio step with the lowest gear ratio i the first or second shifting dement A or B associated with the splitter group GV and the third or fourth shifting element C or D associated with the main transmission group HG are dosed.

With reference to the specific gearset layouts, for example it emerges from FIG. 1 that between the lower gear ratio steps 1 to 7, large, or larger gear intervals phi 2 with a value of around 1.46 are provided, whereas between the higher gear ratio steps 7 to 10 small, or smaller gear intervals phi 1 with a value of around 1.21 are provided. Overall, regardless of that a large total spread of 17.4 is obtained, which can also be produced approximately as a maximum even with a geometrical gradation.

From the above, the advantage emerges from the invention that between the highest 4 gear ratio steps or the 4 with the lowest gear ratios provided, the smallest gear intervals phi 1 exist. Thus, for example, with the gearset layout concerned a downshift from a rotational speed of 1000 to 1210 can take place, while in contrast, with known transmissions rotational speeds of at least 1300 are produced. Thus, a finer gradation is obtained. The fact that the larger gear intervals phi 2 are associated with the lower gear ratio steps with higher gear ratios is not a disadvantage, because during driving under acceleration, larger gear intervals phi 2 are in any case advantageous since fewer shifts are needed.

In the shifting matrix shown in FIG. 1B, instead of 12 only 10 gear ratio steps are shown because when the first range-change element L is closed some individual gear ratio steps are omitted. Despite that, these gear ratio steps are still present and can also be used if needs be. Thus, in reality the transmission has 12 gears. Due to the progressive gear gradation, in the context of the invention it is operated as a 10-gear transmission. Moreover, by virtue of the choice of the gear ratios i in the range group GP the overall spread can also be varied,

As shown by the parallel indication of gear ratio steps in FIG. 1B, the gearset shown can also be operated independently, only with a splitter group GV and a main transmission group HG, as already described, as a progressive 6-gear transmission without a range group GP. In the shifting matrix only the gear ratio steps of the first range-change element L, i.e. the gear ratio steps 5 to 10, then correspond to the gear ratio steps 1 to 6.

Thus, it is apparent from the shifting matrix that the larger gear interval phi 2 is provided in gearshifts between the first and second gears, between the second and third gears, between the third and fourth gears, between the fourth and fifth gears, between the fifth and sixth gears and between the sixth and seventh gears. This corresponds to sequential gearshifts between gears 1 and 7 or, in the six-gear variant, between gears 1 to 3. The smaller gear interval phi 1 is obtained in gearshifts between the seventh and eighth gears, between the eighth and ninth gears and between the ninth and tenth gears in the 10-gear design, which in the 6-gear design corresponds to gearshifts between the third and fourth gears, between the fourth and fifth gears and between the fifth and sixth gears, This corresponds to sequential gearshifts between gears 7 to 10 or, in the 6-gear version, between gears 3 to 6.

In detail, it is apparent from FIG. 1B that in the 10-gear version, to obtain the first orward gear the first shifting element A associated with the splitter group GV, the fifth shifting element E associated with the main transmission group HG and the first range-change shifting element L are closed. To obtain the second forward gear the second shifting element B associated with the splitter group GV, the fifth shifting element E associated with the main transmission group HG and the first range-change shifting element L are closed, whereas to obtain the third forward gear the first shifting element A associated with the splitter group GV, the third shifting element C associated with the main transmission group HG and the first range-change shifting element L are closed. To obtain the fourth forward gear the second shifting element B associated with the splitter group GV, the third shifting element C associated with the main transmission group HG and the first range-change shifting element L are closed, whereas to obtain the fifth forward gear the first shifting element A associated with the splitter group GV, the fifth shifting element E associated with the main transmission group HG and the second range-change shifting element H are closed, and to obtain the sixth forward gear the second shifting element B associated with the splitter group CV, the fifth shifting element E associated with the main transmission group HG and the second range-change shifting element H are closed. To obtain the seventh forward gear the first shifting element A associated with the splitter group GV, the third shifting element C associated with the main transmission group HG and the second range-change shifting element H are closed, whereas to obtain the eighth forward gear the first shifting element A associated with the splitter group CV, the fourth shifting element D associated with the main transmission group HG and the second range-change shifting element H are closed. To engage the ninth forward gear the second shifting element B associated with the splitter group GV, the third shifting element C associated with the main transmission group HG and the second range-change shifting element H are closed, and to obtain the tenth forward gear the second shifting element B associated with the splitter group CV, the fourth shifting element D associated with the main transmission group HG and the second range-change shifting element H are closed.

From the shifting matrix shown in FIG. 1B it is clear that with the gearset layout shown in FIG. 1 the ninth gear, or the fifth gear in the 6-gear version, is a direct gear, and a so-termed overdrive gear is the tenth gear, or the sixth gear in the 6-gear version.

FIG. 1D shows a further embodiment of the invention in relation to the gearset layout in FIG. 1, From the shifting matrix it is apparent that a 12-gear variant is associated with the gearset according to FIG. 1. Besides the 12-gear variant, a 6-gear variant is also possible. Further, the shifting scheme according to FIG. 1 shows that to obtain the first forward gear the first of the shifting elements A associated with the splitter group GV, the fifth shifting element E associated with the main transmission group HG and the first range-change shifting element L are dosed. To obtain the second forward gear the second of the shifting elements B associated with the splitter group, the fifth shifting dement E associated with the main transmission group HG and the first range-change shifting element L are dosed, whereas to obtain the third forward gear the first of the shifting elements A associated with the splitter group, the third shifting dement C associated with the main transmission group HG and the first range-change shifting element L are closed. To obtain the fourth forward gear the first shifting element A associated with the splitter group GV, the fourth shifting element D associated with the main transmission group HG and the first range-change shifting element L are closed, whereas to obtain the fifth forward gear the second shifting element B associated with the splitter group GV, the third shifting element C associated with the main transmission group HG and the first range-change shifting element L are closed. To obtain the sixth forward gear the second shifting element B associated with the splitter group GV, the fourth shifting element D associated with the main transmission group HG and the first range-change shifting element L are closed, whereas to obtain the seventh forward gear the first shifting element A associated with the splitter group, the fifth shifting element E associated with the main transmission group HG and the second range-change shifting element H are closed. To obtain the eighth forward gear the second shifting element B associated with the splitter group GV, the fifth shifting element E associated with the main transmission group HG and the second range-change shifting element H are closed, whereas to obtain the ninth forward gear the first shifting element A associated with the splitter group GV, the third shifting element C associated with the main transmission group HG and the second range-change shifting element H are closed. To obtain the tenth forward gear the first shifting element A associated with the splitter group, the fourth shifting element D associated with the main transmission group HG and the second range-change shifting element H are closed, whereas to obtain the eleventh forward gear the second shifting element B associated with the splitter group GV, the third shifting element C associated with the main transmission group HG and the second range-change shifting element H are closed. To obtain the twelfth forward gear the second shifting element B associated with the splitter group GV, the fourth shifting element D associated with the main transmission group HG and the second range-change shifting element H are closed,

From the shifting matrix sown in FIG. 1D it is clear that the gearset layout shown in FIG. 1 is operated as a 12-gear version with a direct gear as its eleventh gear step, or the fifth gear in the 6-gear version, and with an overdrive gear as the twelfth gear step or the sixth gear step in the 6-gear version. Further, the shifting matrix shows that the larger gear interval phi 2 is provided in gearshifts between the first and second gears, between the second and third gears, between the sixth and seventh gears, between the seventh and eighth gears and between the eighth and ninth gears, whereas the smaller gear interval phi 1 is provided in gearshifts between the third and fourth gears, between the fourth and fifth gears and between the fifth and sixth gears. In relation to the 6-gear version this means that the larger gear interval phi 2 is provided for gearshifts between the first and second gears and between the second and third gears, whereas the smaller gear interval phi 1 is provided for gearshifts between the third and fourth gears, between the fourth and fifth gears and between the fifth and sixth gears. This means that there is a sequential shift series in both directions between gears 3 to 6,

According to the shifting matrix shown in FIG. 2B in relation to the gearset layout according to FIG. 2, it is apparent that with the 10-gear version large gear intervals phi 2 are provided between the first six gears, or between the first two gears in the 6-gear version, whereas the small gear intervals phi 1 are provided between the remainder of the gears, In particular this is achieved in that the small gear interval phi 1 is associated with the second and third gears of the main transmission group HG. In the case of the 6-gear version, a large gear interval is provided only for a gearshift between the first gear and the second gear. Small gear intervals phi 1 are provided sequentially between the second gear up to the sixth gear.

In addition it is provided that the highest gear, i.e, the gear with the lowest gear ratio i, is designed as a direct gear. In the 10-gear version this corresponds to the tenth gear and in the 6-gear version to the sixth gear. The direct gear has a gear ratio i equal to 1. Advantageously, in this version there are 4 small gear intervals phi 1.

In detail, the shifting matrix according to FIG. 2B shows that in the 10-gear variant, to obtain the first forward gear the first shifting element A associated with the splitter group GV, the fifth shifting element E associated with the main transmission group HG and the first range-change shifting element L are closed, whereas to obtain the second forward gear the second shifting element B associated with the spotter group GV, the fifth shifting element E associated with the main transmission group HG and the first range-change shifting element L are dosed. To obtain the third forward gear the first shifting element A associated with the splitter group CV, the third shifting element C associated with the main transmission group HG and the first range-change shifting element L are dosed, whereas to obtain the fourth forward gear the second shifting element B associated with the splitter group GV, the third shifting element C associated with the main transmission group HG and the first range-change shifting element L are dosed. To obtain the fifth forward gear the first shifting element A associated with the splitter group GV, the fifth shifting element E associated with the main transmission group HG and the second range-change shifting element H are dosed, whereas to obtain the sixth forward gear the second shifting element B associated with the splitter group GV, the fifth shifting element E associated with the main transmission group HG and the second range-change shifting element H are closed, To obtain the seventh forward gear the first shifting element A associated with the splitter group GV, the fourth shifting element D associated with the main transmission group HG and the second range-change shifting element H are closed, whereas to obtain the eighth forward gear the first shifting element A associated with the splitter group GV, the third shifting element C associated with the main transmission group HG and the second range-change shifting element H are closed. To engage the ninth forward gear the second shifting element B associated with the splitter group, the fourth shifting element D associated with the main transmission group HG and the second range-change shifting element H are closed, whereas to obtain the tenth forward gear the second shifting element B associated with the splitter group GV, the third shifting element C associated with the main transmission group HG and the second range-change shifting element H are closed.

With the gearset layout shown in FIG. 3, a 14-gear version is provided, in which a further, fifth wheel plane 5 is associated with the main transmission group HG. Consequently a further, fourth gear step 4 is also associated with the main transmission group HG. The fifth wheel plane 5 is associated with the sixth shifting element F. The small gear interval phi 1 is associated with the third and fourth gears 3 and 4 of the main transmission group HG. In the gearset layout shown, two further possible gear steps in the associated shifting matrix in FIG. 3B have been omitted. Thus, in theory a 16-gear transmission can be realized with the gearset layout shown in FIG. 3. If there is no range group GP connected downstream from the main transmission group HG, there is also an 8-gear version which, as already mentioned, is also indicated in the shifting matrix of FIG. 3B, wherein the 8 gears of the 8-gear version correspond to gears 7 to 14 in the 14-gear variant.

From the shifting matrix according to FIG. 3B it is also clear that large gear intervals phi 2 are provided between the first 11 gears and small gear intervals phi 1 between the last 4 gears. In the 8-gear version this means that the large gear intervals phi 2 are provided between the first 5 gears and small gear intervals phi 1 between the last 4 gears. Furthermore the second-lowest gear ratio, i.e. the thirteenth gear in the 14-gear version, and the seventh gear in the 8-gear version, are direct gears, whereas the lowest gear ratio, i.e. the fourteenth gear or eighth gear respectively, are so-termed overdrive gears.

In detail, referring to the 14-gear variant, it can be seen from the shifting scheme shown in FIG. 3B that to obtain the first forward gear the first shifting element A associated with the splitter group GV, the sixth shifting element F associated with the main transmission group HG and the first range-change shifting element L are closed. To obtain the second forward gear the second shifting element B associated with the splitter group GV, the sixth shifting element F associated with the main transmission group HG and the first range-change shifting element L are closed, whereas to obtain the third forward gear the first shifting element A associated with the splitter group GV, the fifth shifting element E associated with the main transmission group HG and the first range-change shifting element L are closed. To obtain the fourth forward gear the second shifting element B associated with the splitter group GV, the fifth shifting element E associated with the main transmission group HG and the first range-change shifting element L are closed, whereas to obtain the fifth forward gear the first shifting element A associated with the splitter group, the third shifting element C associated with the main transmission group HG and the first range-change shifting element L are closed. To produce the sixth forward gear the second shifting element B associated with the splitter group GV, the third shifting element C associated with the main transmission group HG and the first range-change shifting element L are closed, whereas to obtain the seventh forward gear the first shifting element A associated with the splitter group GV, the sixth shifting element F associated with the main transmission group HG and the second range-change shifting element H are dosed. To obtain the eighth forward gear the second shifting element B associated with the splitter group GV, the sixth shifting element F associated with the main transmission group HG and the second range-change shifting element H are closed, whereas to obtain the ninth forward gear the first shifting element A associated with the splitter group GV, the fifth shifting element E associated with the main transmission group NG and the second range-change shifting element H are closed. To obtain the tenth forward gear the second shifting element B associated with the splitter group, the fifth shifting element E associated with the main transmission HG and the second range-change shifting element H are closed, whereas to obtain the eleventh forward gear the first shifting element A associated with the splitter group GV, the third shifting element C associated with the main transmission group HG and the second range-change shifting element H are closed. To obtain the twelfth forward gear the first shifting element A associated with the splitter group GV, the fourth shifting element D associated with the main transmission group HG and the second range-change shifting element H are closed, whereas to obtain the thirteenth forward gear the second shifting element B associated with the sputter group GV, the third shifting element C associated with the main transmission group HG and the second range-change shifting element H are closed. To obtain the fourteenth forward gear the second shifting element B associated with the splitter group, the fourth shifting element D associated with the main transmission group HG and the second range-change shifting element H are closed.

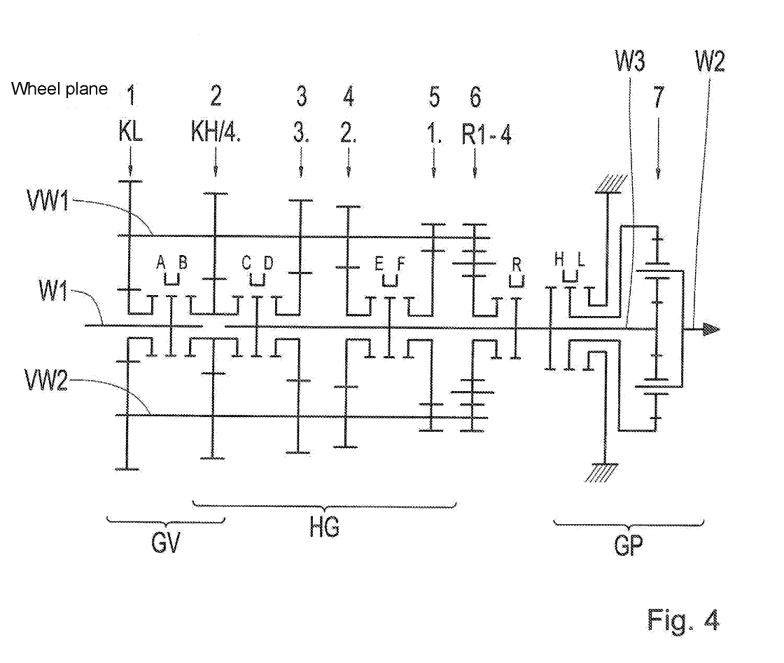

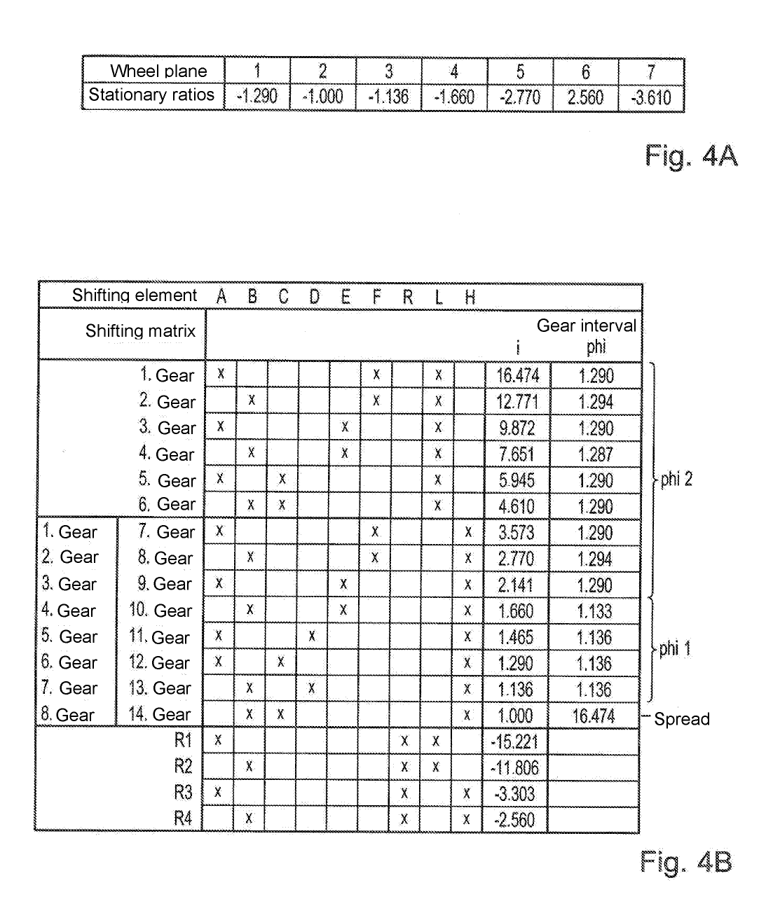

FIG. 4 shows a gearset layout that relates to a 14-gear or an 8-gear design, wherein the seventh to fourteenth gears correspond to the first to eighth gears in the 8-gear version. In these embodiments the highest gear in each case, i.e. the one with the lowest gear ratio i, is a direct gear with gear ratio i equal to 1. Moreover, in these embodiments at least 4 small gear intervals phi 1 are provided between the five highest gears (10 to 14 in the 14-gearversion and 4 to 8 in the 8-gear version). The large, or larger gear interval phi 2 is associated with the first 10 gears in the 14-gear version, whereas the large gear interval phi 2 is associated with the first 4 gears in the 8-gear version.

The gearset layout shown in FIG. 4 corresponds essentially to the gearset layout shown in FIG. 2, but a spur gear plane 5 and an additional shifting element F, and thereby an additional gear are associated with the main transmission group HG.

Referring to the 14-gear variant, it emerges in detail from the shifting matrix shown in FIG. 4B that to obtain the first forward gear the first shifting element A associated with the splitter group GV, the sixth shifting element F associated with the main transmission group HG and the first range-change shifting element L are closed, whereas to obtain the second forward gear the second shifting element B associated with the splitter group GV, the sixth shifting element F associated with the main transmission group HG and the first range-change shifting element L are closed. To obtain the third forward gear the first shifting element A associated with the splitter group GV, the fifth shifting element E associated with the main transmission group HG and the first range-change shifting element L are closed, whereas to obtain the fourth forward gear the second shifting element B associated with the splitter group, the fifth shifting element E associated with the main transmission group HG and the first range-change shifting element L are closed. To obtain the fifth forward gear the first shifting element A associated with the splitter group, the third shifting element C associated with the main transmission group HG and the first range-change shifting element L are closed, whereas to obtain the sixth forward gear the second shifting element B associated with the splitter group, the third shifting element C associated with the main transmission group HG and the first range-change shifting element L are closed. To obtain the seventh forward gear the first shifting element A associated with the splitter group GV, the sixth shifting element F associated with the main transmission group HG and the second range-change shifting element H are closed, whereas to obtain the eighth forward gear the second shifting element B associated with the splitter group GV, the sixth shifting element F associated with the main transmission group HG and the second range-change shifting element H are closed. To engage the ninth forward gear the first shifting element A associated with the splitter group GV, the fifth shifting element E associated with the main transmission group HG and the second range-change shifting element H are closed, whereas to obtain the tenth forward gear the second shifting element B associated with the splitter group GV, the fifth shifting element E associated with the main transmission group HG and the second range-change shifting element H are closed. To obtain the eleventh forward gear the first shifting element A associated with the splitter group GV, the fourth shifting element D associated with the main transmission group HG and the second range-change shifting element H are closed, whereas to obtain the twelfth forward gear the first shifting element A associated with the splitter group GV, the third shifting element C associated with the main transmission group HG and the second range-change shifting element H are closed. To obtain the thirteenth forward gear the second shifting element B associated with the splitter group GV, the fourth shifting element D associated with the main transmission group HG and the second range-change shifting element H are closed, and to obtain the fourteenth forward gear the second shifting element B associated with the splitter group GV, the third shifting element C associated with the main transmission group HG and the second range-change shifting element H are closed.

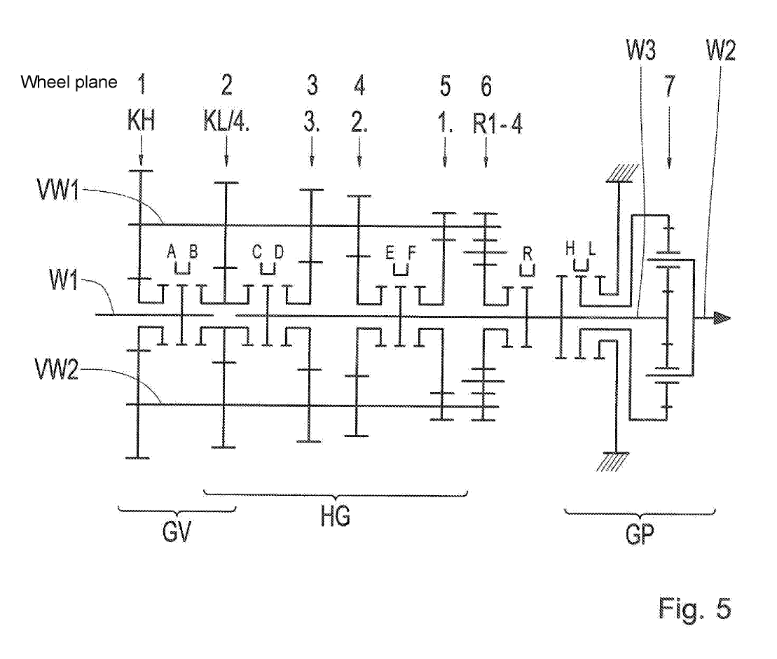

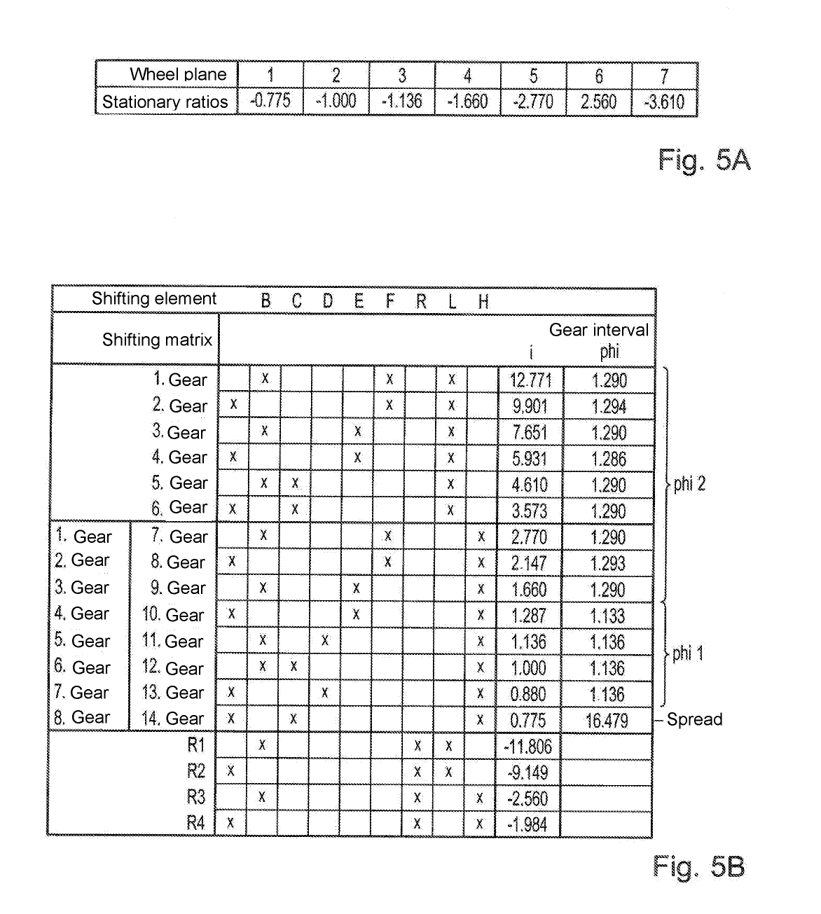

From the gearset layout shown in FIG. 5, a 14-gear or 8-gear embodiment is possible, in which the drive input constants KH and KL in the splitter group are exchanged so that the drive input constant KH is associated with the first spur gear plane 1 and the drive input constant KL is associated with the second spur gear plane. Furthermore, the gearset layout comprises two overdrive gears, namely the thirteenth and fourteenth gears, or the seventh and eighth gears in the 8-gear version. In the 14-gear version the twelfth gear, and in the 8-gear version the sixth gear are direct gears. Regardless of which of the 14-gear or 8-gear versions is concerned, the gearset layout comprises four small gear intervals phi 1 which are provided between the five highest gears. Moreover 9 large gear intervals phi 2 are provided, which in the 14-gear variant are between the first 10 gears. In the 8-gear variant the large gear intervals phi 2 are provided between the first 4 gears.

It is conceivable for the gearset layout shown in FIG. 5 to be combined with the gearset layout shown in FIG. 3, in such manner that a transmission gearset with 3 overdrive gears is produced.

Referring to the 14-gear variant, from the shifting matrix in FIG. 5B it can be seen that to obtain the first forward gear the second shifting element B associated with the splitter group GV, the sixth shifting element F associated with the main transmission group HG and the first range-change shifting element L are closed, whereas to obtain the second forward gear the first shifting element A associated with the splitter group GV, the sixth shifting element F associated with the main transmission group HG and the first range-change shifting element L are closed. To obtain the third forward gear the second shifting element B associated with the splitter group GV, the fifth shifting element E associated with the main transmission group HG and the first range-change shifting element L are closed, whereas to obtain the fourth forward gear the first shifting element A associated with the splitter group GV, the fifth shifting element E associated with the main transmission group HG and the first range-change shifting element L are closed. To obtain the fifth forward gear the second shifting element B associated with the splitter group GV, the third shifting element C associated with the main transmission group HG and the first range-change shifting element L are closed, whereas to obtain the sixth forward gear the first shifting element A associated with the splitter group GV, the third shifting element C associated with the main transmission group HG and the first range-change shifting element L are closed. To obtain the seventh forward gear the second shifting element B associated with the splitter group GV, the sixth shifting element F associated with the main transmission group HG and the second range-change shifting element H are closed, whereas to obtain the eighth forward gear the first shifting element A associated with the splitter group GV, the sixth shifting element F associated with the main transmission group HG and the second range-change shifting element H are closed. To engage the ninth forward gear the second shifting element B associated with the splitter group GV, the fifth shifting element E associated with the main transmission group HG and the second range-change shifting element H are closed, whereas to obtain the tenth forward gear the first shifting element A associated with the splitter group, the fifth shifting element E associated with the main transmission group HG and the second range-change shifting element H are closed. To obtain the eleventh forward gear the second shifting element B associated with the splitter group GV, the fourth shifting element D associated with the main transmission group HG and the second range-change shifting element H are closed, whereas to obtain the twelfth forward gear the second shifting element B associated with the splitter group GV, the third shifting element C associated with the main transmission group HG and the second range-change shifting element H are closed. To obtain the thirteenth forward gear the first shifting element A associated with the splitter group, the fourth shifting element D associated with the main transmission group HG and the second range-change shifting element H are closed, whereas to obtain the fourteenth forward gear the first shifting element A associated with the splitter group, the third shifting element C associated with the main transmission group HG and the second range-change shifting element H are closed.

Regardless of the various gearset layouts, for example 4 reversing gear ratios R1 to R4 can be obtained. Advantageously, the reversing gear steps R1 and R2 have a larger gear interval phi 2. This enables faster reversing in the slow range group.

From the shifting matrices shown in FIGS. 1B, 1D, 2B, 3B and 4B it can be seen that to obtain a first reversing gear the first shifting element A associated with the splitter group GV, the shifting element R associated with the main transmission group HG and the first range-change shifting element L are closed, whereas to obtain a second reversing gear R2 the second shifting element B associated with the splitter group GV, the shifting element R associated with the main transmission group HG and the first range-change shifting element L are closed. To obtain a third reversing gear R3 the first shifting element A associated with the splitter group GV, the shifting element R associated with the main transmission group HG and the second range-change shifting element H are closed, whereas to obtain a fourth reversing gear R4 the second shifting element B associated with the splitter group GV, the shifting element R associated with the main transmission group HG and the second range-change shifting element H are closed.

From the shifting scheme shown in FIG. 5B, it can be seen that to obtain the first reversing gear R1 the second shifting element B associated with the splitter group GV, the shifting element R associated with the main transmission group HG and the first range-change shifting element L are closed, whereas to obtain a second reversing gear R2 the first shifting element A associated with the splitter group GV, the shifting element R associated with the main transmission group HG and the first range-change shifting element L are closed. To obtain a third reversing gear R3 the second shifting element B associated with the splitter group GV, the shifting element R associated with the main transmission group HG and the second range-change shifting element H are closed, whereas to obtain a fourth reversing gear R4 the first shifting element A associated with the splitter group GV, the shifting element R associated with the main transmission group HG and the second range-change shifting element H are closed.

For the respective numerical values of the stationary gear ratios, the gear ratios i and the respective gear intervals phi, reference should be made to the individual tables in the figures. Preferably, the gear interval phi 2 designated as the larger one is the square of the gear interval phi 1 designated as the smaller one.

### Indexes

1 First spur gear plane
2 Second spur gear plane
3 Third spur gear plane
4 Fourth spur gear plane
5 Fifth spur gear plane
6 Reversing-gear spur gear plane R1-4
7 Range group in the form of a wheel plane
A First shifting element associated with the splitter group
B Second shifting element associated with the spotter group
C Third shifting element associated with the main transmission group
D Fourth shifting element associated with the main transmission group
E Fifth shifting element associated with the main transmission group
F Sixth shifting element associated with the main transmission group
R Shifting element for reversing gears
KL Drive constant of the splitter group in the slow mode
KH Drive constant of the splitter group in the fast mode
L First range-change shifting element
H Second range-change shifting element
W1 Drive input shaft
W2 Drive output shaft
W3 Main shaft
VW1 First countershaft
VW2 Second countershaft
GV Splitter group
HG Main transmission group
GP Downstream range group in the form of a planetary gearset
phi 1 Smaller gear interval or transmission ratio interval
phi 2 Larger gear interval or transmission ratio interval
i Transmission ratio of the individual gear

1-11. (canceled)

12. A method of operating an automated transmission having a main transmission group (HG) and at least one splitter group (GV) for producing at least six gears, the method comprising choosing a gear interval (phi 1) at least during a gearshift between gears with a lowest gear ratio (i) and a second-lowest gear ratio (i) to be smaller than the gear interval (phi 2) at least between gears with a highest gear ratio (i) and a second-highest gear ratio (i);
at least during the gearshift between the gears with the lowest gear ratio (i) and the second-lowest gear ratio (i), not changing a shifting element (A, B) in use associated with the splitter group and changing a shifting element (C, D, E) in use associated with the main transmission group (HG); and
at least during the gearshift between the gears with the highest gear ratio (i) and the second-highest gear ratio (i), not changing a shifting element (C, D. E) in use associated with the main transmission group (HG) and changing a shifting element (A, B) in use associated with the splitter group (GV).

13. The method according to claim 12, further comprising:
engaging a first shifting element (A) associated with the splitter group (GV) and either a fifth or a sixth shifting element (E or F) associated with the main transmission group (HG) to obtain the gear with the highest gear ratio (i); and
engaging a second shifting element (B) associated with the splitter group (GV) and either the fifth or the sixth shifting element (E or F) associated with the main transmission group (HG) to obtain the gear with the second-highest gear ratio (i).

14. The method according to claim 12, further comprising:
engaging either a first or a second shifting element (A or B) associated with the splitter group (GV) and either a third or a fourth shifting element (C or D) associated with the main transmission group (HG) to obtain the gear with the second-lowest gear ratio (i); and
engaging either the first or the second shifting element (A or B) associated with the splitter group (GV) and either the third or the fourth shifting element (C or D) associated with the main transmission group (HG) to obtain the gear with the lowest gear ratio (i),

15. The method according to claim 12, wherein the larger gear interval (phi 2) corresponds approximately to the smaller gear interval (phi 1) squared.

16. A transmission having a main transmission group (HG) and at least one splitter group (GV), the transmission comprising:
at least first, second, third and fourth spur gear planes (1, 2, 3, 4) and at least five shifting elements (A. B, C, D, E) being associated with the spur gear planes (1, 2, 3, 4) for producing at least six gears;
at least in a gearshift between gears with a lowest gear ratio (i) and a second-lowest gear ratio (i), a smaller gear interval (phi 1) is provided than a gear interval (phi 2) at least in a gearshift between gears with a highest gear ratio (i) and a second-highest gear ratio (I);
at least in the gearshift between the gears with the lowest gear ratio (i) and the second-lowest gear ratio (i), one shifting element (A, B) in use associated with the splitter group (GV) remains engaged and further shifting element (C, D, E) in use associated with the main transmission group (HG) is changable; and
at least in the gearshift between the gears with the highest gear ratio (i) and the second-highest gear ratio (i), the further shifting element (C, 0, E) in use associated with the main transmission group (HG) remains engaged and the one shifting element (A, B) in use associated with the splitter group (GV) is changable.

17. The transmission according to claim 16, wherein to obtain the gear with the highest gear ratio (i), a first shifting element (A) associated with the splitter group (GV) and either a fifth or a sixth shifting element (E or F) associated with the main transmission group (HG) is engaged, and to obtain the gear with the second-highest gear ratio (i), a second shifting element (B) associated with the splitter group (G V) and the fifth or the sixth shifting element (E or F) associated with the main transmission group (HG) is engaged.

18. The transmission according to claim 16, wherein to obtain the gear with the second-lowest gear ratio (i), either a first or a second shifting element (A or B) associated with the splitter group (GV) and either a third or a fourth shifting element (C or D) associated with the main transmission group (HG) is engaged, and to produce the gear with the lowest gear ratio (i) either the first or the second shifting element (A or B) associated with the splitter group (GV) and either the third or the fourth shifting element (C or D) associated with the main transmission group (HG) are engaged.

19. The transmission according to claim 16, wherein the smaller gear interval (phi 1) is determined by a ratio between stationary gear ratios of the second spur gear plane (2) and the third spur gear plane (3).

20. The transmission according to claim 16, wherein the larger gear interval (phi 2) is determined by a ratio between stationary gear ratios of the first spur gear plane (1) and the second spur gear plane (2).

21. The transmission according to claim 16, wherein to obtain two further gears, a fifth spur gear plane (5) and a sixth shifting element (F) are associated with the main transmission group (HG).

22. The transmission according to claim 16, wherein a range group (GP), in a form of a planetary gearset with a first range-change shifting element (L) and a second range-change shifting element (H), is connected downstream from the main transmission group (HG) such that at least four to six further gears can be obtained.
